(19) United States
(12) Patent Application Publication
(10) Pub. No.: US 2003/0186657 A1
(43) Pub. Date: Oct. 2, 2003

(54) Method for estimating a mobile radiotelephone channel, and mobile radiotelephone receiving device

(76) Inventors: Yingjie Gao, Moers (DE); Benjamin Schwarze, Krefeld (DE)

Correspondence Address: HARNESS, DICKEY & PIERCE, P.L.C., P.O.BOX 8910, RESTON, VA, 20195, US

(21) Appl. No.: 10/332,530

(22) PCT Filed: May 8, 2002
(86) PCT No.: PCT/DE02/01668

(30) Foreign Application Priority Data
May 10, 2001 (DE) 101 22 689.6

(51) Int. Cl. H04B 1/00

(52) U.S. Cl. 455/130; 455/334; 455/134

(57) ABSTRACT

The invention relates to a method for estimating a channel of a mobile radiotelephone channel during a multipath reception. According to said method, an interpolation of the channel coefficients which are determined on the basis of the respective impulse response, in two adjacent time intervals (slot 1 and slot 2), is carried out. Before said interpolation, the individual components of the impulse response are examined to determine whether they belong to one and the same transmission path, and an interpolation is only carried out for the components to which this applies. (1′ and 1″ resp. 3′ and 3″)

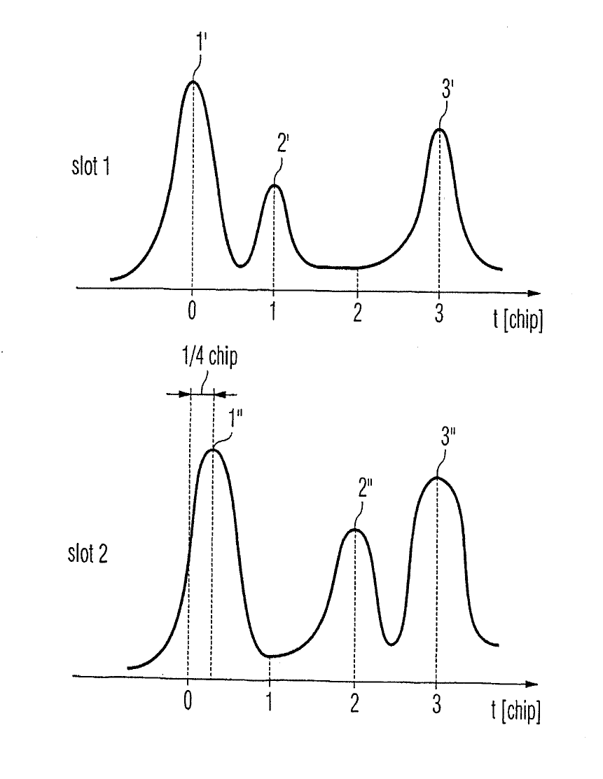

Method for estimating a mobile radio channel, and mobile radio receiving device.

The invention relates to a method for estimating a mobile radio channel according to the preamble of claim 1 and to a mobile radio receiving device.

In a mobile radio channel, signals propagate over a number of paths in practical operation. Every single received signal exhibits a different delay, amplitude and Doppler shift in accordance with its transmission path. The various received signals become superimposed at the antenna of a receiver, either constructively or destructively, and, as a result, impede the detection of the useful data transmitted by the signals.

In particular, such a multipath propagation of a radio signal produces channel impulse responses which are stretched in time and which lead to a delay spread and thus to a shifted temporal relation between the individual symbols of the transmitted signal. In mobile radio systems operating in accordance with the wideband code division multiplex (W-CDMA) method, special receivers (or RAKE receivers) are therefore used for processing the multipath signals.

Such a RAKE receiver provides a distinct gain due to the utilization of multipath signals which arrive with different propagation delays at a receiving antenna of a mobile radio device. For this purpose, the signal coming from the antenna is processed in a number of paths, the so-called “fingers” of the RAKE receiver. Each of these fingers is adjusted to one component each of the received multipath signals with in each case an optimized phase angle of the pseudo noise sequences which have been used for coding a signal to be transmitted via the mobile radio channel.

In an IS-95 mobile radio system, a RAKE receiver of a mobile station has at least three such fingers and that of a base station has at least four such fingers. Furthermore, there is at least one “search finger” each both in the mobile station and in the base station, which continuously searches for stronger multipath signals. As soon as the search finger detects a stronger multipath signal, the finger of the previously weakest multipath signal is optimally adjusted to the new stronger multipath signal. Typically, it is possible to demodulate by this means up to three of the strongest multipath signals in the mobile station and up to four of the strongest multipath signals in the base station, with a time delay of at least 0.8 to 1 μs and to advantageously combine them by means of maximum ratio combining.

Because of the time variance and frequency selectivity of the mobile radio channel, the data detection should be adaptive and coherent. For this purpose, both the time-discrete channel impulse responses must be estimated on the basis of the received signal and the transmitted data symbols must be detected on the basis of the time-discrete channel impulse responses. The former process is also briefly called channel estimation. There is a refined theory for the channel estimation; compare, for example, P. Jung: “Analyse und Entwurf digitaler Mobilfunksysteme” [Analysis and Design of Digital Mobile Radio Systems], Stuttgart 1997, Chapter 5.

Adaptive coherent data detectors for channel estimation can only be used meaningfully if, in addition to the message to be transmitted (the useful data), the message components known to the receiver are transmitted. These are then used for the actual channel estimation and called training sequences. They can be located at the beginning or in the center of a complete subscriber signal (burst). In modern multiple access systems of the type of W-CDMA (Wideband Code Division Multiple Access), so-called pilot bits are in each case transmitted at the beginning or the end of a transmission timeslot (slot) for channel estimation. These pilot bits are used for calculating the channel coefficients valid during the respective slot.

To estimate the transmission channel more accurately, the calculated channel coefficients are interpolated between two adjacent slots. This interpolation can lead to false results if the channel coefficients calculated in adjacent slots, which are used in the interpolation, do not travel along the same path of multipath propagation.

To illustrate this problem, reference is made to the FIGURE in which the impulse response of two adjacent timeslots slot 1 and slot 2 is drawn as a function of the time—represented in chip units. Both impulse responses in slot 1 and slot 2 in each case have three peaks which are called 1′, 2′ and 3′ (in slot 1) and 1″, 2″ and 3″ (in slot 2). Whereas the displacement of the peak 1″ compared with 1′ is about ¼ chip, the displacement of the peak 2″ compared with 2′ is approximately 1 chip and no displacement is shown between peaks 3″ and 3′.

Using all these peaks (“fingers”) for the interpolation of the channel coefficients between slots 1 and 2 leads to incorrect results in accordance with the investigations of the inventors.

The invention is, therefore, based on the object of providing an improved method for channel estimation which supplies more accurate and more reliable results.

This object is achieved by a method having the features of claim 1.

The invention includes the fundamental concept of carrying out, before any interpolation of the channel coefficients calculated from the impulse responses, a comparative check of the impulse responses in the two slots to see whether the individual peaks can be really allocated to the same propagation paths. Only those components (particularly peaks) of the channel impulse response which can be allocated to one and the same transmission path in both slots are used for the abovementioned interpolation.

The invention is preferably carried out via a determination of the time displacement of the individual peaks or fingers of the impulse response experienced by these between the two timeslots, and subsequent threshold discrimination of the time displacement values.

It is especially when the difference in the temporal position of the peaks (“finger positions”) is less than ¼ chip that it is assumed that the channel coefficients determined on the basis of the finger positions represent the same transmission path (which is occasionally also called “channel” by the specialists in this field). Thus, the predetermined threshold value of discrimination is ¼ chip.

In the FIGURE already mentioned above, fingers 1′ and 1″ and 3′ and 3″ can thus be used for an interpolation but not fingers 2′ and 2″.

The embodiment of the concept of the invention as a device will normally be in software but it can also be supported—at least partially—by means of hard-wired logic. In principle, the mobile radio receiving device embodying the device aspect can be implemented both in a terminal (mobile telephone) and in a base station since the channel estimation mentioned, in principle, can be practiced both in the uplink and in the downlink.

1. A method for estimating a mobile radio channel in the case of multipath reception, in which an interpolation of the channel coefficients determined in two adjacent timeslots on the basis of the respective impulse response is carried out,
characterized in that,
before the interpolation the individual components of the impulse response are checked to determine whether they belong to one and the same transmission path, and an interpolation is only carried out for those components to which this applies.

2. The method as claimed in claim 1,
characterized in that
the checking comprises a determination of the time displacement of the individual fingers or peaks of the impulse response between the adjacent timeslots and a threshold value discrimination of the time displacement found with a predetermined threshold value.

3. The method as claimed in claim 2,
characterized in that
a value of ¼ chip is set as threshold value for the threshold value discrimination.

4. A mobile radio receiving device in which a method as claimed in one of the preceding claims is implemented.
